(19) United States
(12) Patent Application Publication
(10) Pub. No.: US 2026/0008233 A1
(43) Pub. Date: Jan. 8, 2026

(54) ARCHITECTURAL 3D PRINTING APPARATUS USING CAPSULES STORING PRINTING MATERIALS

(71) Applicant: POSTECH RESEARCH AND BUSINESS DEVELOPMENT FOUNDATION, Pohang-si (KR)

(72) Inventors: Ju Hong PARK, Pohang-si (KR); Jeong-eun YANG, Pohang-si (KR); Saeji PARK, Pohang-si (KR)

(21) Appl. No.: 19/189,485

(22) Filed: Apr. 25, 2025

(30) Foreign Application Priority Data
Jul. 4, 2024 (KR) 10-2024-0087882
Jan. 20, 2025 (KR) 10-2025-0008158

(51) Int. Cl. B29C 64/255; B29C 48/02; B29C 48/475; B29C 64/118; B29C 64/209; B29C 64/264; B29C 64/295; B29C 64/321; B29C 64/393; B29K 511/00; B29L 31/10; B33Y 30/00; B33Y 40/00; B33Y 50/02; E04G 21/04

(52) U.S. Cl. CPC B29C 64/255; B29C 48/02; B29C 48/475; B29C 64/118; B29C 64/209; B29C 64/264; B29C 64/295; B29C 64/321; B29C 64/393; B33Y 30/00; B33Y 40/00; B33Y 50/02; E04G 21/04; B29K 2511/00; B29L 2031/10

(57) ABSTRACT

An architectural 3D printing apparatus that utilizes a replaceable material capsule comprises: a material extrusion unit is configured to move a piston in a forward direction, pressurize a printing material stored in a material capsule, and extrude the printing material; and a capsule fixing unit is positioned beneath the material extrusion unit and is coupled to the material capsule, ensuring that the inner storage space of the material capsule, which contains the printing material, is aligned with the piston, wherein the material capsule comprises: a body designed in a columnar shape with an open top surface, which contains the inner storage space formed therein; and a nozzle is attached to the bottom surface of the body, through which the printing material is discharged.

### CROSS-REFERENCE TO RELATED APPLICATION

This application claims priority under 35 U.S.C § 119 to Korean Patent Application No. 10-2024-0087882 filed on Jul. 4, 2024, and Korean Patent Application No. 10-2025-0008158 filed on Jan. 20, 2025, in the Korean Intellectual Property Office, the entire contents of these applications are hereby incorporated by reference.

### TECHNICAL FIELD

The disclosure relates to an architectural 3D printing apparatus.

### BACKGROUND

The contents set forth in this section merely provide background information on the present embodiments and do not constitute prior art.

General architectural 3D printing apparatuses typically operate using a large frame, such as a gantry system, which imposes significant constraints on the workspace. These limitations may restrict their application for certain types of buildings. Furthermore, because they require substantial quantities of printing materials, such as concrete, these systems can only be utilized in environments where the properties of the materials can be effectively maintained to facilitate the extrusion process.

Due to these structures, the operation of typical architectural 3D printing apparatuses can be greatly affected by natural factors such as temperature changes, and accordingly, a stable operation may not be guaranteed when used in extreme climatic environmental conditions such as polar regions or deserts, and even if they work, deformation or defects are expected during the printing process, which in turn may require substantial effort to complete and manage large-scale projects.

Therefore, there is a need for technology to overcome such issues.

The present application was made based on the research results of STEAM Research (R & D) Project of the National Research Foundation of Korea in the Ministry of Science and ICT (2710006420), Agricultural and Food Science and Technology Convergence Research Personnel Training (R & D) Project of the Korea Institute of Planning and Evaluation for Technology in Food, Agriculture and Forestry in the Ministry of Agriculture, Food and Rural Affairs (2540000349), High Value-Added Food Technology Development (R& D) Project of the Korea Institute of Planning and Evaluation for Technology in Food, Agriculture and Forestry in the Ministry of Agriculture, Food and Rural Affairs (2540000316), Multi-Species Food Ink and Meat Substitute Production Technology Development Project with Multi-Nozzle 3D Printing Technique Applied thereto of the Korea Institute of Planning and Evaluation for Technology in Food, Agriculture and Forestry in the Ministry of Agriculture, Food and Rural Affairs (4002931501), and Food Technology Research and Development Project of the Gyeongsangbuk-do Provincial Office and Pohang City Hall (GBTP2023129001) of the Republic of Korea.

### SUMMARY

It is the objective of the present disclosure to provide an architectural 3D printing apparatus using material capsules containing printing materials stored therein so that it can be used in extreme environments, such as polar regions, deserts, space, etc.

In addition, it is an object of the present disclosure to provide an architectural 3D printing apparatus that efficiently 3D prints buildings by using printing materials that utilize biopolymers and local soil where the buildings are to be constructed.

The objects of the present disclosure are not limited to the objects mentioned above, and other objects and advantages of the present disclosure that have not been mentioned can be understood by the following description and will be more clearly understood by the embodiments of the present disclosure. Moreover, it will be readily appreciated that the objects and advantages of the present disclosure can be realized by the means set forth in the claims and combinations thereof.

According to certain aspects of the disclosure, an architectural 3D printing apparatus utilizing a replaceable material capsule comprises: a material extrusion unit designed to move a piston in a forward direction, pressurize a printing material stored within the material capsule, and extrude the printing material, and a capsule fixing unit that is disposed under the material extrusion unit, to which the material capsule is attached, ensuring that the inner storage space of the material capsule, containing the printing material is stored is disposed in line with the piston, wherein the material capsule comprises: a body provided in a columnar shape with an open top surface and having the inner storage space formed therein, and a nozzle that is coupled to the bottom surface of the body, through which the printing material is discharged, and wherein the printing material comprises one or more of a biopolymer and soil of a region where the building is to be constructed.

According to some aspects, the material extrusion unit comprises: a motor configured to receive a signal from the outside and operate; a piston rod disposed under the motor and configured to rotate by receiving power from the motor; and a pressurizing unit configured to pressurize the printing material by moving the piston in the first direction by rotation of the piston rod.

According to some aspects, the pressurizing unit comprises: a rotation shaft coupled with the piston rod and configured to rotate by the rotation of the piston rod; a movable member coupled with the rotation shaft and configured to move in the first direction or a second direction opposite to the first direction by rotation of the rotation shaft; the piston coupled to a bottom side of the movable member and configured to pressurize the printing material by movement of the movable member in the first direction; and a guide rail disposed parallel to the rotation shaft and coupled with the movable member, and configured to guide the movable member to move in the first direction or the second direction.

According to some aspects, the piston is inserted into the inner storage space of the material capsule and pressurizes the printing material.

According to some aspects, the material capsule further comprises a coupling plate protruding outward along a top surface rim of the body, and wherein the capsule fixing unit comprises: an upper fixing unit to which the coupling plate is coupled; a lower fixing unit that is spaced apart from the upper fixing unit by a certain distance and forms a placement space in which the material capsule is disposed, and into which the nozzle is inserted; and a connecting unit coupled to each of one side of the upper fixing unit and one side of the lower fixing unit, and connecting the upper fixing unit and the lower fixing unit.

According to some aspects, the upper fixing unit comprises: a first plate having a first insertion hole formed therein into which the piston is inserted; a second plate disposed spaced apart from the first plate by a predetermined distance, having a second insertion hole formed therein into which the body of the material capsule is inserted, and having one side thereof opened to thereby have a part of the second insertion hole opened; and a connecting plate connecting the first plate and the other side of the second plate.

According to some aspects, the lower fixing unit is provided in a hexahedral shape with a top surface and one side surface thereof opened, and has a third insertion hole formed in a bottom surface thereof into which the nozzle is inserted.

According to some aspects, the material capsule is coupled to the capsule fixing unit by having the nozzle inserted into the third insertion hole and the coupling plate inserted into a separation space between the first plate and the second plate.

According to some aspects, the material curing unit comprises: a microwave output unit configured to irradiate the printing material printed through the nozzle with microwaves; and a UV light output unit configured to irradiate the printing material printed through the nozzle with UV light.

According to some aspects, the material capsule further comprises a thermal module disposed in the body and configured to heat the printing material stored in the inner storage space of the body.

According to some aspects, the thermal module comprises: a heating coil disposed on an inner circumferential surface of the body and configured to heat the printing material; a hot end surrounding and coupled with the nozzle, and configured to heat the nozzle; and a temperature sensor disposed under the body and configured to measure a temperature of the body or the nozzle.

Since the architectural 3D printing apparatus of the present disclosure uses a material capsule having a printing material stored therein, it can have a more compact modular structure than that of conventional architectural 3D printing apparatuses that use a large feed apparatus that feeds printing materials such as concrete, and can thus greatly reduce constraints in the workspace and work relatively easily even in complex spaces with flexible and adaptable designs.

Further, since biopolymers and the local soil where the building is to be located are utilized as printing materials, it can also be applied in space environments based on basalt-like soil such as the Moon or Mars, or extreme environments such as polar regions and deserts.

In addition, since the printing material can be cured quickly at the same time as it is extruded via UV light and microwaves, the printing speed can be greatly improved, thereby shortening the time to complete large-scale projects.

Furthermore, since the printing material can be kept at a temperature that makes it easy to discharge by heating the material capsule with the thermal module, the printing material can be printed precisely.

In addition to the descriptions above, specific effects of the present disclosure will be described together while describing specific details for carrying out the present disclosure below.

### BRIEF DESCRIPTION OF THE DRAWINGS

FIG. 1 is a perspective view of an architectural 3D printing apparatus according to one embodiment of the present disclosure.

FIG. 2 is an example diagram schematically showing the operation of the architectural 3D printing apparatus according to one embodiment of the present disclosure.

FIG. 3 is a perspective view of the material extrusion unit shown in FIG. 1.

FIG. 4 is a perspective view of the material capsule shown in FIG. 1.

FIG. 5 is a perspective view of the material capsule shown in FIG. 1.

FIG. 6 is a top plan view of the material capsule shown in FIG. 5.

FIG. 7 is a side cross-sectional view of the material capsule shown in FIG. 5.

FIG. 8 is a perspective view of the capsule fixing unit shown in FIG. 1.

FIG. 9 shows the perspective view of the section cut by the cutting line A-A′ of FIG. 8.

FIG. 10 is an example diagram to explain the process of combining the material capsule and the capsule fixing unit.

FIG. 11 is an example diagram to explain the operation of injecting the output material embedded in the material capsule.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

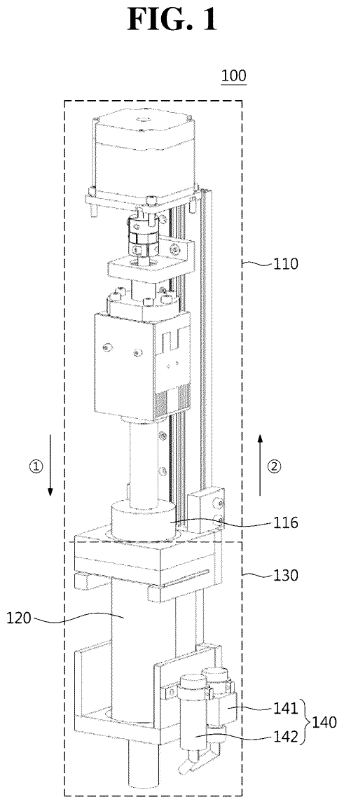

Hereinafter, an architectural 3D printing apparatus according to embodiments of the present disclosure will be described in detail with reference to FIGS. 1 to 8.

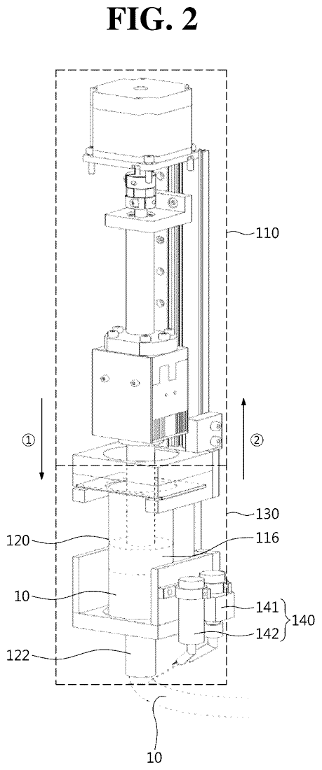

FIG. 1 is the perspective view of an architectural 3D printing apparatus according to one embodiment of the present disclosure, and FIG. 2 is the example diagram schematically showing the operation of the architectural 3D printing apparatus according to one embodiment of the present disclosure.

First, the architectural 3D printing apparatus will be described with reference to FIGS. 1 and 2. Referring to FIG. 1, the architectural 3D printing apparatus 100 may include a material extrusion unit 110, a material capsule 120, a capsule fixing unit 130, and a material curing unit 140.

The material extrusion unit 110 may pressurize the printing material stored in the material capsule 120 by moving a piston 116 in a first direction 1, thereby extruding the printing material. The capsule fixing unit 130 may be disposed under the material extrusion unit 110, and the material capsule 120 may be coupled thereto so that an inner storage space of the material capsule 120 in which the printing material is stored is disposed in line with the piston 116. Next, the material curing unit 140 may cure the printing material printed through the nozzle of the material capsule 120. In this case, the material capsule 120 may be configured in a form that can be coupled to and released from the capsule fixing unit 130 in the form of a cartridge. Further, the printing material may be one or more of a biopolymer and soil (e.g., lunar soil) of the region in which a building is to be constructed.

Describing the operation of the architectural 3D printing apparatus 100 broadly by referring to FIG. 2, the material extrusion unit 110 moves the piston 116 in the first direction \textcircled{1} and pressurizes and extrudes the printing material 10 stored in the material capsule 120. Next, when the printing material 10 stored in the material capsule 120 coupled to the capsule fixing unit 130 is all extruded, the material extrusion unit 110 moves the piston 116 in the second direction \textcircled{2}. Thereafter, when the coupled material capsule 120 is released and another material capsule 120 is coupled by a manager, the piston 116 is moved in the first direction \textcircled{1} again to pressurize and extrude the printing material 10 stored in the material capsule 120.

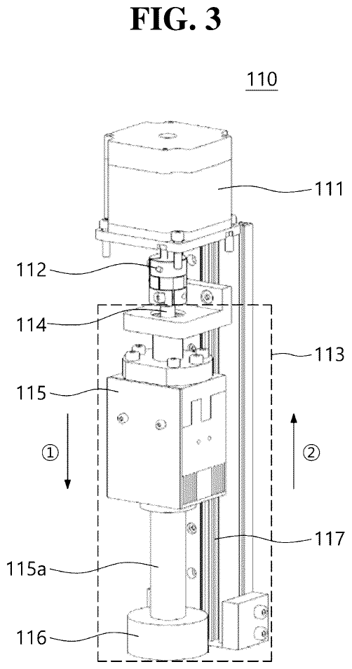

Referring to FIGS. 3 to 7, each component will be described in detail.

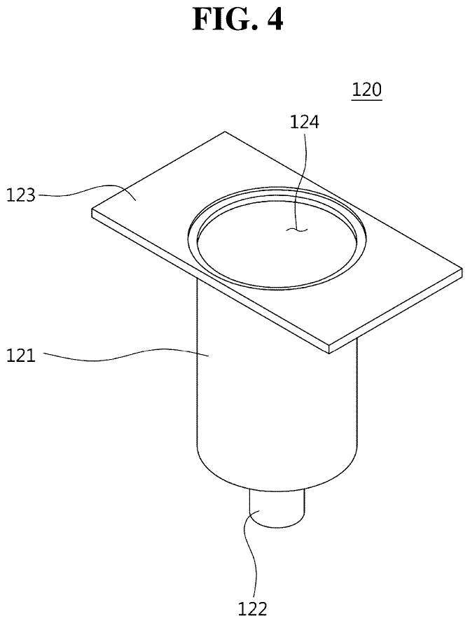

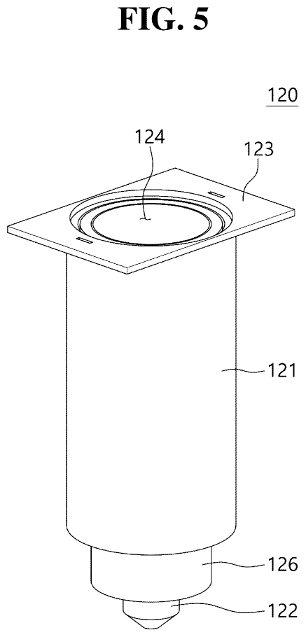

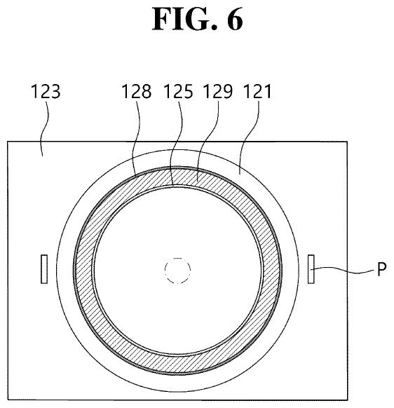

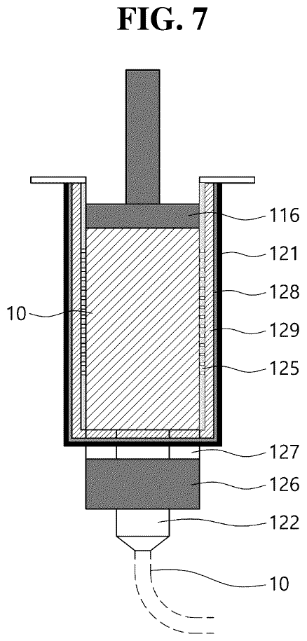

FIG. 3 is a perspective view of the material extrusion unit shown in FIG. 1, FIG. 4 is a perspective view of the material capsule shown in FIG. 1, FIG. 5 is a perspective view of the material capsule shown in FIG. 1, FIG. 6 is a top plan view of the material capsule shown in FIG. 5, FIG. 7 is a side cross-sectional view of the material capsule shown in FIG. 5.

First, the material extrusion unit 110 will be described with reference to FIG. 3. The material extrusion unit 110 may include a motor 111, a piston rod 112, and a pressurizing unit 113 in order to perform the operation of extruding the printing material stored in the material capsule 120.

The motor 111 may receive a signal from the outside and operate to generate power, and the piston rod 112 may be disposed under the motor 111 and rotate by receiving power from the motor 111. Next, the pressurizing unit 113 may move the piston 116 in the first direction (1) by the rotation of the piston rod 112 and pressurize the printing material in the material capsule 300.

The pressurizing unit 113 may include a rotation shaft 114, a movable member 115, a piston 116, and a guide rail 117.

The rotation shaft 114 may be coupled with the piston rod 112 and rotate by the rotation of the piston rod 112. The movable member 115 may be coupled to the rotation shaft 114 with the rotation shaft 114 passing therethrough, and move in the first direction \textcircled{1} or the second direction \textcircled{2} opposite to the first direction \textcircled{1} by the rotation of the rotation shaft 114. The piston 116 may be coupled to the bottom side of the movable member 115, and pressurize the printing material stored in the material capsule 130 as the movable member 115 moves in the first direction \textcircled{1}. In this case, the piston 116 may be coupled with a columnar coupling member 115a of the movable member 115, and may be inserted into the internal space of the material capsule 130 and receive a pressing force via the coupling member 115a to pressurize and extrude the printing material.

Next, the guide rail 117 may be disposed parallel to the rotation shaft 114 and coupled with the movable member 115, and may guide the movable member 115 to move in the first direction \textcircled{1} or the second direction \textcircled{2}.

Referring to FIG. 4, the material capsule 120 will be described. The material capsule 120 is what stores therein a printing material consisting of one or more of a biopolymer and soil of a region where a building is to be constructed, and may be replaced when the printing material stored therein is used up.

The material capsule 120 may include a body 121, a nozzle 122, and a coupling plate 123. The body 121 may be provided in a columnar shape with an open top surface, and have an inner storage space 124 formed therein. The nozzle 122 may be coupled to the bottom surface of the body 121 and guide the discharge of the printing material 10. The coupling plate 123 may protrude outward along the rim of the top surface of the body 121 and may be coupled with the capsule fixing unit 130 to be described later.

Referring to FIGS. 5 to 7, the material capsule 120 may further include a thermal module. The thermal module may receive a signal from the outside and heat the printing material 10 stored in the body 121, and may measure the internal temperature of the body 121 and transmit it to the outside.

More specifically, the thermal module may include a heating coil 125, a hot end 126, and a temperature sensor 127. The heating coil 125 may be disposed on the inner circumferential surface of the body 121 and may heat the printing material. The hot end 126 may surround the nozzle 122 and be coupled with the nozzle 122, and may melt the printing material 10 discharged to the outside through the nozzle 122 by heating the nozzle 122. The temperature sensor 127 may be disposed under the body 121 and measure the temperature of the body 121 or the nozzle 122. In this case, the temperature sensor 127 may be provided as a first sensor that measures the temperature of the body 121 and a second sensor that measures the temperature of the nozzle 122. The heating coil 125 and the hot end 126 may be supplied with electric power by having electric wires, which supply electric power via a power connection P, coupled thereto.

In addition, the thermal module may include a control unit (not shown). The control unit (not shown) may receive a control signal from an external control system and adjust the temperature of the heating coil 125 and the hot end 126. Further, the control unit (not shown) may receive the temperature of the body 121 or the nozzle 122 from the temperature sensor 127 and transmit it to the external control system.

Accordingly, since the temperature of the heating coil 125 and the hot end 126 can be adjusted according to the printing material 10 or the temperature of the heating coil 125 and the hot end 126 can be adjusted according to the temperature of the body 121 and the nozzle 122, the printing material 10 can be kept at a temperature that makes it easy to discharge, thereby enabling the printing material 10 to be printed precisely.

In this case, the body 121 may include a coating layer 128 and a heat insulation 129. The coating layer 128 may be formed on the inner surface of the body 121, and can protect the inner surface from being damaged by the operation of the piston 116 of the body 121 pressurizing the printing material 10 and discharging the printing material 10 to the outside. The heat insulation 129 may be disposed between the inner surface of the body 121 and the heating coil 125 and thus prevent heat loss, and can minimize the effect of external temperature and thereby maintain the quality of the printing material 10.

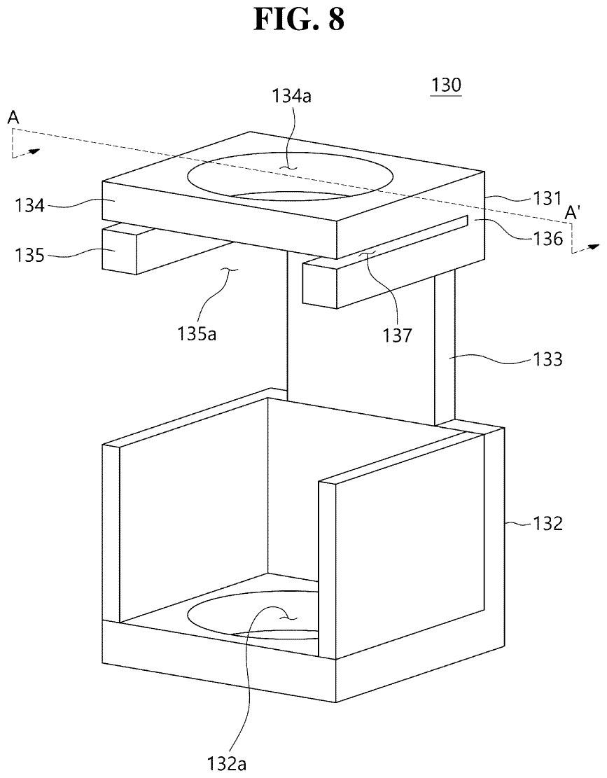

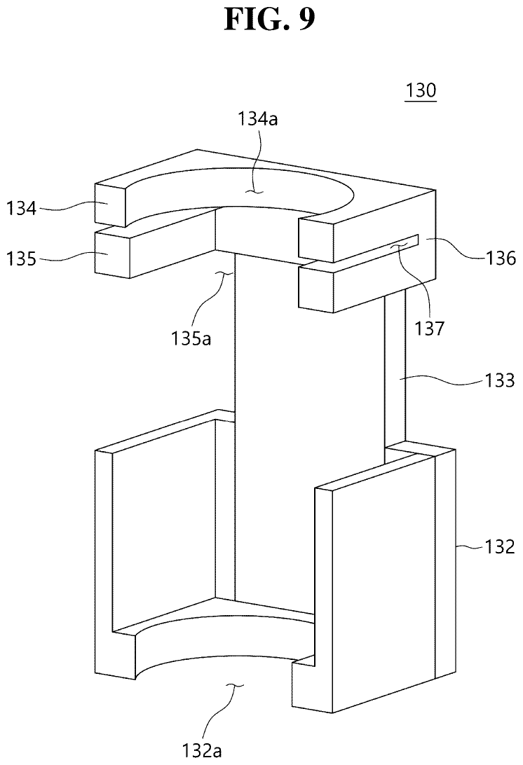

FIG. 8 is the perspective view of the capsule fixing unit shown in FIG. 1, FIG. 9 shows the perspective view of the section cut by the cutting line A-A′ of FIG. 8. Next, the capsule fixing unit 130 will be described with reference to FIGS. 8 and 9. The capsule fixing unit 130, to which the material capsule 120 may be coupled, may include an upper fixing unit 131, a lower fixing unit 132, and a connecting unit 133 so that the inner storage space 124 of the coupled material capsule 120 can be disposed in line with the piston 116.

The upper fixing unit 131 may be coupled with the coupling plate 123 of the material capsule 120, and the lower fixing unit 132 may be spaced apart from the upper fixing unit 131 by a certain distance and thus form a placement space in which the material capsule 120 is disposed, and the nozzle 122 of the material capsule 120 may be inserted.

Further, the connecting unit 133 may be provided in a plate shape and have one side thereof coupled with one side of the upper fixing unit 131 and the other side coupled with one side of the lower fixing unit 132 to thereby connect the upper fixing unit 131 and the lower fixing unit 132, and may maintain a spaced distance between the upper fixing unit 131 and the lower fixing unit 132 to thus form a placement space in which the material capsule 120 is disposed.

More specifically, the upper fixing unit 131 may include a first plate 134, a second plate 135, and a connecting plate 136. The first plate 134 may be provided in a plate shape, and may have a first insertion hole 134a formed in its center into which the piston 116 is inserted. In this case, the size of the first insertion hole 134a may be formed to be larger than the cross-sectional size of the piston 116 so that the piston 116 can be inserted.

In addition, the second plate 135 may be shaped like a plate and positioned at a predetermined distance from the first plate 134. It may also feature a second insertion hole 135a, which is designed to accommodate the body 121 of the material capsule 120. In this configuration, one side of the second plate 135 may be left open, allowing the body 121 of the material capsule 120 to be inserted. Consequently, the second plate 135 may have one side open, enabling the body 121 of the material capsule 120 to be inserted into the second insertion hole 135a, thereby partially exposing the second insertion hole 135a to be opened in part.

As the first plate 134 and the second plate 135 are positioned at a predetermined distance apart from each other, a separation space 137 is created between them. The coupling plate 123 of the material capsule 120 can be inserted into and connected with the separation space 137.

The connecting plate 136 may be attached on one side to the first plate 134 and on the other side to the second plate 135. This configuration connects the first plate 134 and the second plate 135 while simultaneously maintaining a separation distance between them.

The lower fixing unit 132 may be positioned at a certain distance from the upper fixing unit 131 and is designed in a hexahedral shape with the top surface and one side surface open. It features a third insertion hole 132a formed in the bottom surface, into which the nozzle 122 of the material capsule 120 is inserted. The diameter of the third insertion hole 132a is larger than the cross-sectional size of the nozzle 122, allowing for easy insertion of the nozzle 122 from the material capsule 120. Additionally, the diameter of the third insertion hole 132a is smaller than the cross-sectional size of the body 121, providing support for the body 121 beneath it. Furthermore, the open sides of the second plate 135 of both the upper fixing unit 131 and the lower fixing unit 132 are aligned, facilitating the straightforward insertion of the material capsule 120 through the open side.

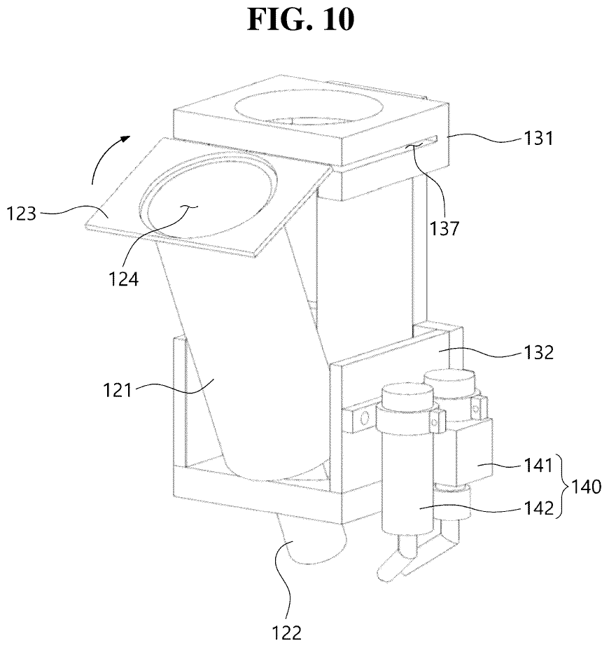

FIG. 10 presents a diagram illustrating the process of combining the material capsule and the capsule fixing unit. The subsequent section will describe the operation by which the material capsule 120 and the capsule fixing unit 130 are coupled, with reference to FIG. 10.

In the process of coupling the material capsule 120 with the capsule fixing unit 130, the nozzle 122 of the material capsule 120 is inserted into the third insertion hole 132a through the open side of the lower fixing unit 132. Consequently, the lower portion of the body 121 is first inserted into the lower fixing unit 132 of the capsule fixing unit 130. Next, the coupling plate 123 can be inserted into the separation space 137 formed in the upper fixing unit 131, allowing the body 121 to be positioned within the placement space between the upper fixing unit 131 and the lower fixing unit 132. This process effectively couples the material capsule 120 with the capsule fixing unit 130. In this way, the inner storage space 124 of the material capsule 120, now coupled to the capsule fixing unit 130, aligns in line with the first insertion hole 134a and the piston 116.

The material curing unit 140 will be described again with reference to FIGS. 1 and 2. The material curing unit 140 may be positioned on one side of the capsule fixing unit 130, specifically adjacent to the lower fixing unit 132. It is designed to cure the printing material by irradiating it with one or more sources of microwaves and ultraviolet (UV) light, which are applied to the material extruded through the nozzle 122.

To achieve this, the material curing unit 140 may consist of a microwave output unit 141 and a UV light output unit 142. The microwave output unit 141 can emit microwaves to irradiate the printing material 10 that has been extruded through the nozzle 122, while the UV light output unit 142 can emit UV light to cure the same printing material 10. This process effectively cures the nozzle 122 with the UV light, thereby curing the printing material 10 extruded through the nozzle 122. Additionally, the material curing unit 140 may receive a signal from the outside and operate one or both of the microwave output unit 141 and the UV light output unit 142.

The printing material is simultaneously cured by the microwave output unit 141 and the UV light output unit 142 at the same time as it is extruded and formed into a printed product. During this process, the microwave output unit 141 cures the interior of the printing material, while the UV light output unit 142 cures the exterior.

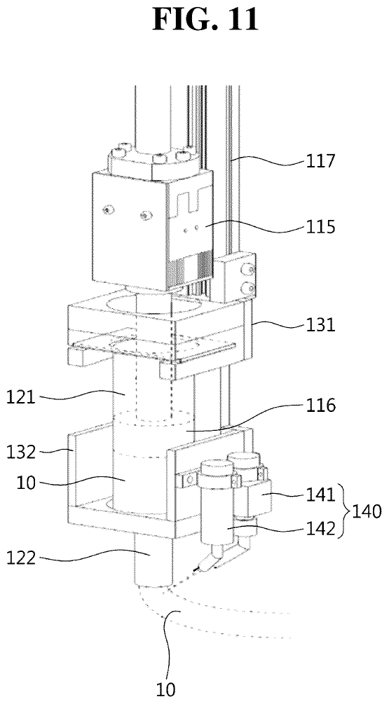

FIG. 11 illustrates a diagram that explains the operation of injecting the output material embedded within the material capsule. The functioning of the architectural 3D printing apparatus 100, which is designed for extruding the printing material, will be described with reference to FIG. 11. When the motor 111 is activated by an external operation signal, the movable member 115 descends, causing the piston 116 to pressurize the printing material 10 stored in the body 121 of the material capsule 120. Subsequently, the printing material 10 can be extruded through the nozzle 122. Additionally, the material curing unit 140 can simultaneously cure the printing material 10 as it is extruded, resulting in the formation of a printed product.

The architectural 3D printing apparatus 100 described in this disclosure features a replaceable material capsule 120, allowing for a more compact modular design compared to traditional architectural 3D printing systems that utilize a large feed apparatus for materials such as concrete. This innovative design significantly minimizes workspace constraints, facilitating operation even in complex environments.

In addition, because each component of the architectural 3D printing apparatus 100 described in the present disclosure is constructed from materials that are resistant to high temperatures, and because printing materials that incorporate biopolymers and local soil are utilized, the apparatus ensures operational stability in extreme environments. Consequently, it can be effectively applied in challenging conditions, such as polar regions and deserts.

The description provided above serves as an illustrative example of the technical concepts associated with the present embodiments. Individuals with ordinary skill in the relevant technical field will be able to make various modifications and adaptations without deviating from the essential characteristics of the present embodiment. Consequently, the present embodiments are intended not to limit but to describe the technical concepts they encompass. The scope of these technical ideas is not confined to the specific embodiments presented. The protection afforded to the present embodiments should be interpreted in accordance with the claims outlined below, and all technical concepts that fall within the equivalent scope should be considered as part of the rights associated with the present embodiments.

While the inventive concept has been specifically illustrated and described with reference to exemplary embodiments, it will be understood by those skilled in the art that various modifications in form and detail may be made without departing from the spirit and scope of the inventive concept as defined by the following claims. Therefore, it is intended that the embodiments be regarded in all respects as illustrative rather than restrictive, with reference to the appended claims rather than the preceding description to indicate the scope of the disclosure.

### DESCRIPTION OF REFERENCE SYMBOLS

100: Architectural 3D printing apparatus
110: Material extrusion unit
120: Material capsule
130: Capsule fixing unit
140: Material curing unit

What is claimed is:

1. An architectural 3D printing apparatus that utilizes a replaceable material capsule, comprising:
a material extrusion unit designed to move a piston in a primary direction, pressurize a printing material stored within a material capsule, and extrude the printing material; and
a capsule fixing unit is positioned beneath the material extrusion unit and is coupled to the material capsule, ensuring that the inner storage space of the material capsule, where the printing material is stored, is aligned with the piston,
wherein the material capsule comprises:
a body designed in a columnar shape with an open top surface, featuring an inner storage space formed therein; and
a nozzle is attached to the bottom surface of the body, through which the printing material is discharged, and wherein the printing material consists of one or more components, including a biopolymer and soil from the region where the building is to be constructed.

2. The architectural 3D printing apparatus of claim 1, wherein the material extrusion unit comprises:
a motor configured to receive a signal from the outside and operate;
a piston rod disposed under the motor and configured to rotate by receiving power from the motor; and
a pressurizing unit configured to pressurize the printing material by moving the piston in the first direction by rotation of the piston rod.

3. The architectural 3D printing apparatus of claim 2, wherein the pressurizing unit comprises:
a rotation shaft connected to the piston rod, designed to rotate in response to the movement of the piston rod; and
a movable member connected to the rotation shaft and configured to move in a first direction or a second direction, which is opposite to the first direction, as a result of the rotation of the shaft,
wherein the piston is coupled to the bottom side of the movable member and is configured to pressurize the printing material through the movement of the movable member in the first direction; and
wherein a guide rail is positioned parallel to the rotation shaft and is coupled with the movable member. It is designed to direct the movable member to move in either the first direction or the second direction.

4. The architectural 3D printing apparatus of claim 3, wherein the piston is inserted into the inner storage space of the material capsule and pressurizes the printing material.

5. The architectural 3D printing apparatus of claim 1, wherein the material capsule further comprises a coupling plate protruding outward along a top surface rim of the body, and
wherein the capsule fixing unit comprises:
an upper fixing unit to which the coupling plate is coupled;
a lower fixing unit that is spaced apart from the upper fixing unit by a certain distance and forms a placement space in which the material capsule is disposed, and into which the nozzle is inserted; and
a connecting unit coupled to each of one side of the upper fixing unit and one side of the lower fixing unit, and connecting the upper fixing unit and the lower fixing unit.

6. The architectural 3D printing apparatus of claim 5, wherein the upper fixing unit comprises:
a first plate having a first insertion hole formed therein into which the piston is inserted;
a second plate disposed spaced apart from the first plate by a predetermined distance, having a second insertion hole formed therein into which the body of the material capsule is inserted, and having one side thereof opened to thereby have a part of the second insertion hole opened; and
a connecting plate connecting the first plate and the other side of the second plate.

7. The architectural 3D printing apparatus of claim 6, wherein the lower fixing unit is configured in a hexahedral shape with an open top surface and one side surface. It features a third insertion hole located on its bottom surface, into which the nozzle is inserted.

8. The architectural 3D printing apparatus of claim 7, wherein the material capsule is coupled to the capsule fixing unit by having the nozzle inserted into the third insertion hole and the coupling plate inserted into a separation space between the first plate and the second plate.

9. The architectural 3D printing apparatus of claim 1, further comprising:
a material curing unit configured to cure the printing material printed through the nozzle.

10. The architectural 3D printing apparatus of claim 9, wherein the material curing unit comprises:
a microwave output unit configured to irradiate the printing material printed through the nozzle with microwaves; and
a UV light output unit configured to irradiate the printing material printed through the nozzle with UV light.

11. The architectural 3D printing apparatus of claim 1, wherein the material capsule further comprises a thermal module disposed in the body and configured to heat the printing material stored in the inner storage space of the body.

12. The architectural 3D printing apparatus of claim 11, wherein the thermal module comprises:
a heating coil disposed on an inner circumferential surface of the body and configured to heat the printing material;
a hot end surrounding and coupled with the nozzle, and configured to heat the nozzle; and
a temperature sensor disposed under the body and configured to measure a temperature of the body or the nozzle.
